(19) United States
(12) Patent Application Publication
(10) Pub. No.: US 2016/0120139 A1
(43) Pub. Date: May 5, 2016

(54) CULTIVATION APPARATUS HAVING AUTOMATIC RAINWATER SUPPLY FUNCTION

(71) Applicants: Hoon Jae LEE, Chungcheongnam-do (KR); Kyeng Ja LEE, Chungcheongnam-do (KR)

(72) Inventors: Hoon Jae LEE, Chungcheongnam-do (KR); Kyeng Ja LEE, Chungcheongnam-do (KR)

(21) Appl. No.: 14/893,220

(22) PCT Filed: May 15, 2015
(86) PCT No.: PCT/KR2015/004874

§ 371 Date: Nov. 23, 2015

(30) Foreign Application Priority Data
May 15, 2014 (KR) 10-2014-0058368

(51) Int. Cl. A01G 27/04; A01G 27/00

(52) U.S. Cl. CPC A01G 27/04; A01G 27/008

(57) ABSTRACT

Disclosed is a cultivation apparatus having an automatic rainwater supply function, which constantly maintains a predetermined water level by filtering and storing rainwater and automatically supplies water to plants through the circulation of water, including the discharge of water whose level exceeds a predetermined level, storage of the water, and supply of the water.

### TECHNICAL FIELD

The present invention relates to a cultivation apparatus having an automatic rainwater supply function, and more particularly, to a cultivation apparatus having an automatic rainwater supply function, which constantly maintains a predetermined water level by filtering and storing rainwater and automatically supplies water to plants through the circulation of water, including the discharge of water whose level exceeds a predetermined level, storage of the water, and supply of the water.

### BACKGROUND ART

Generally, in order to grow plants using a hydroponic system, culture soil, sponge, cotton, etc. are put in a cultivation container having drainage holes formed in the bottom, plants are planted or seeds are sown in the cultivation container, and the cultivation container is put on a drainage tray.

However, because the use of such hydroponic equipment requires proper irrigation according to the kind of plant, the moisture content of the culture soil, etc., a cultivator must pay careful attention to irrigation, without which the plants would wither.

Further, there is a problem in that when plants are cultivated in a plurality of cultivation containers, water must be supplied to all the cultivation containers one by one.

As a related technique for solving the above problems, a streamlet using a cultivation box using rainwater is disclosed in Korean Patent Publication No. 10-2010-0107665.

This disclosure shows that a rainwater storage tank is provided in a lower portion of a large-scale box configured to store rainwater, a support frame for supporting a small pot, a sand filtering layer, a pebble filtering layer, etc. is provided in an upper portion of the box, and a small pot is put on the support frame.

Therefore, the water level in the storage tank can be adjusted according to the kind of plant by storing rainwater, and a certain amount of rainwater can be secured in the lower portion of the box.

However, when plants are cultivated using filtered rainwater, such a cultivation box cannot be used for a long time because it cannot store a large amount of rainwater, even during the rainy season, and the interior of the cultivation box may be damaged by rainwater.

Further, there is inconvenience in that water must be supplied from the outside when a large amount of rainwater cannot be stored in the cultivation box because of drought.

### DISCLOSURE

### Technical Problem

Therefore, the present invention has been made in view of the above problems, and it is an object of the present invention to provide a cultivation apparatus having an automatic rainwater supply function, which constantly supplies water at a predetermined level to plants by storing a large amount of rainwater using a tank configured to filter and store rainwater, and prevents plants from withering through the circulation of water, including the discharge of water whose level exceeds a predetermined level, storage of the water and re-supply of the water.

### TECHNICAL SOLUTION

In accordance with an aspect of the present invention, the above and other objects can be accomplished by the provision of a cultivation apparatus having an automatic rainwater supply function to cultivate plants using rainwater stored therein, the cultivation apparatus including a rainwater storage tank for receiving and storing rainwater, a return tank for storing water flowing thereinto through a pump and discharging the water stored therein, a water storage tank connected with the rainwater storage tank and the return tank through overflow pipes, the water storage tank receiving and storing water whose level is higher than the overflow pipes, a water level adjustment tank for receiving water from the water storage tank and the return tank through supply pipes and discharging water through the overflow pipe, which is connected with the return tank, if a water level in the water level adjustment tank exceeds a predetermined level, and a cultivation unit including a reservoir connected with the water level adjustment tank through a water transfer pipe to receive and discharge water so as to maintain the same water level as that in the water level adjustment tank, and a pot plate, to which a pot for planting plants is mounted.

When the water level is higher than the overflow pipes, which are connected with the rainwater storage tank, the water storage tank, the return tank and the water level adjustment tank, the water may flow into the overflow pipes and may be discharged from the overflow pipes.

The supply pipes may be provided with plugs coupled to ends thereof inside the water level adjustment tank, each of the plugs being connected with a buoyant float so as to control the amount of water that flows into the water level adjustment tank.

The cultivation unit may include a pot plate having a through-hole, in which the pot is fitted, and a reservoir coupled to a bottom portion of the pot plate to store water and supply the water to plants planted in the pot through a wick.

The pot plate may include a guide groove for guiding rainwater and a water inflow recess for allowing the rainwater guided by the guide groove to flow into the reservoir, the guide groove and the water inflow recess being formed in a top surface of the pot plate.

### ADVANTAGEOUS EFFECTS

The present invention provides a cultivation apparatus having an automatic rainwater supply function, which prevents plants from withering by filtering and storing a large amount of rainwater in a tank and constantly supplying the water at a predetermined level to plants, and achieves the circulation of water, including the discharge of water whose level exceeds a predetermined level, storage of the water and re-supply of the water, thereby facilitating plant cultivation without spending much time.

Further, since the number of cultivation units can be decreased or increased as is suitable for the installation site, the cultivation apparatus according to the present invention can be installed in a wide variety of locations.

### DESCRIPTION OF DRAWINGS

FIG. 1 is a plan view illustrating the constitution of a cultivation apparatus having an automatic rainwater supply function according to the present invention;

FIG. 2 is a sectional view illustrating the circulation of rainwater according to the present invention;

FIG. 3 is a sectional view illustrating the operational state of a water level adjustment tank according to the present invention;

FIG. 4 is a perspective view illustrating a cultivation unit according to the present invention;

FIG. 5 is a sectional view illustrating the state in which water is supplied to the cultivation unit according to the present invention; and

FIG. 6 is a sectional view illustrating the state in which the cultivation unit according to the present invention is separately installed.

### BEST MODE

Hereinafter, a cultivation apparatus having an automatic rainwater supply function according to the present invention will be described in detail with reference to the accompanying drawings.

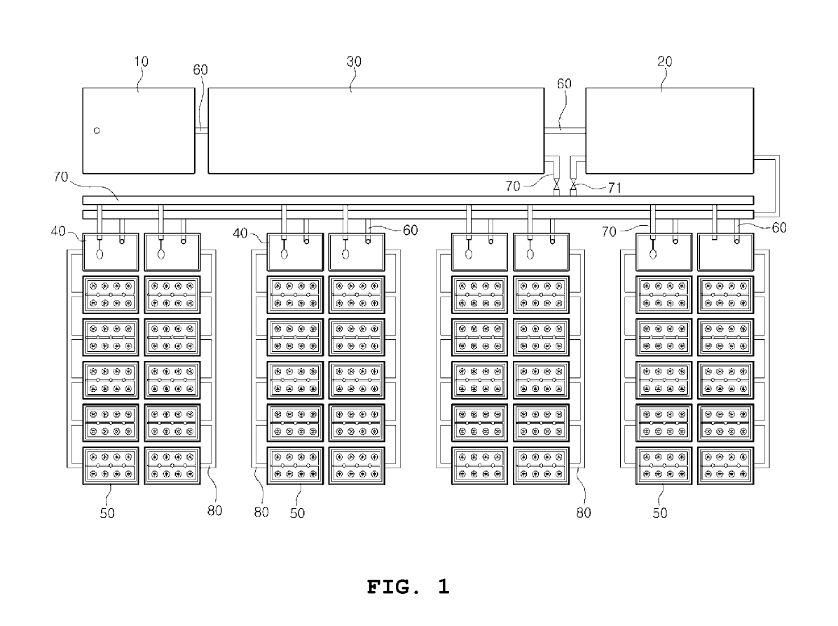

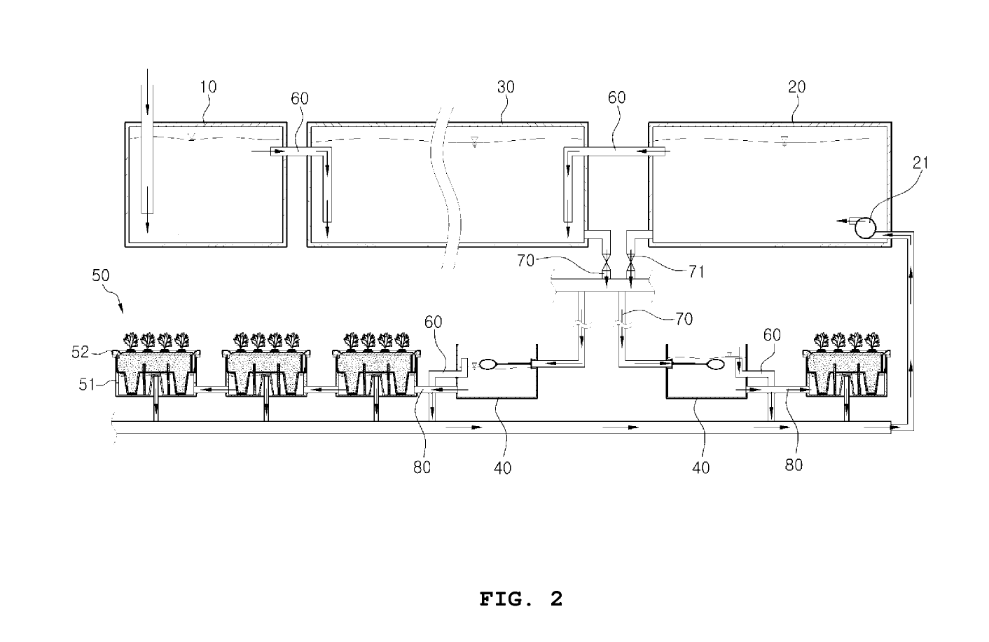

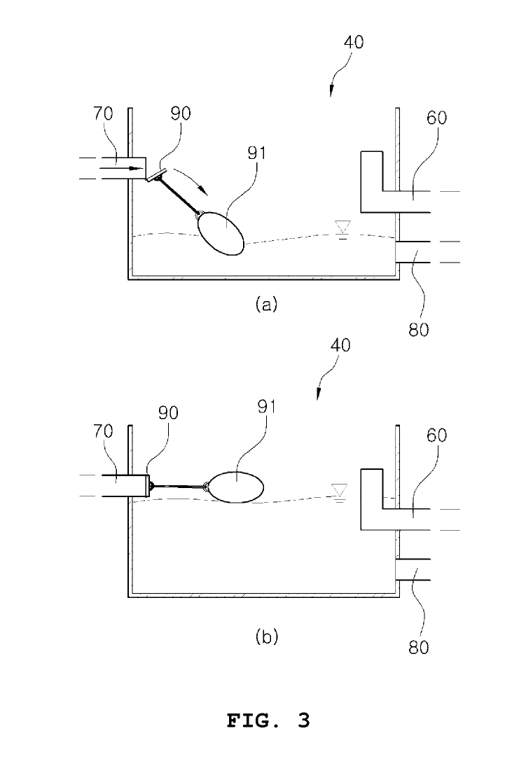

FIG. 1 is a plan view illustrating the constitution of a cultivation apparatus having an automatic rainwater supply function according to the present invention, FIG. 2 is a sectional view illustrating the circulation of rainwater according to the present invention, and FIG. 3 is a sectional view illustrating the operational state of a water level adjustment tank according to the present invention.

As shown in FIGS. 1 through 3, the present invention provides a cultivation apparatus having an automatic rainwater supply function, which constantly maintains a predetermined water level by filtering and storing rainwater and automatically supplies water to plants through the circulation of water, including the discharge of water whose level exceeds a predetermined level, storage of the water, and supply of the water.

The cultivation apparatus having an automatic rainwater supply function comprises five units, including a rainwater storage tank 10, a return tank 20, a water storage tank 30, a water level adjustment tank 40, and a cultivation unit 50.

The rainwater storage tank 10 stores rainwater supplied from a roof, an eave or the like, filters the rainwater to remove impurities therefrom, and discharges the filtered rainwater.

The return tank 20 stores water that flows thereinto through a pump, and discharges the water if the level thereof exceeds a predetermined level.

The water storage tank 30 is connected with the rainwater storage tank 10 and the return tank 20 through overflow pipes 60 so as to receive and store the water whose level is higher than the overflow pipes 60.

The water level adjustment tank 40 is connected with the water storage tank 30 and the return tank 20 through supply pipes 70 so as to receive the water, and if the water level in the water level adjustment tank 40 exceeds a predetermined level, the water is discharged through the overflow pipe 60 that is connected with the return tank 20.

That is, the rainwater, which has been filtered in the rainwater storage tank 10, is supplied to and stored in the water storage tank 30, and the water stored in the water storage tank 30 is supplied to the water level adjustment tank 40 through the supply pipes 70 that are connected with the water storage tank 30 and the return tank 20.

As the water is supplied to the water level adjustment tank 40, the water in the water level adjustment tank 40, whose level is higher than the overflow pipe 60 coupled to the water level adjustment tank 40, is discharged.

The return tank 20 stores the water that flows thereinto through the pump 21, and if the water level in the return tank 20 exceeds a predetermined level, the water is discharged through the overflow pipe 60, and is supplied to the water storage tank 30.

Each of the overflow pipes 60, which are coupled to the rainwater storage tank 10, the water storage tank 30, the return tank 20 and the water level adjustment tank 40, has a water inlet port, which is located at an upper portion of each tank so that water flows into the water inlet port when the water level in the tank is higher than the overflow pipe 60.

Each overflow pipe 60 further has a water outlet port, which is located at a lower portion of each tank for the discharge of the water entering from the upper portion.

In other words, the overflow pipes 60 are mounted to the return tank 20, the water storage tank 30 and the water level adjustment tank 40 at a predetermined height so as to allow the rainwater to circulate through the tanks when the water level in the tanks exceeds a predetermined level, thereby regulating the water level in the tanks and preventing the rainwater from overflowing the tanks.

As shown in FIG. 2, when the level of the filtered water in the rainwater storage tank 10 is higher than the overflow pipe 60 that is connected with the upper portion of the rainwater storage tank 10, the filtered water flows into the overflow pipe 60 and is discharged to the water storage tank 30.

The water stored in the return tank 20 is supplied to the water level adjustment tank 40 through the supply pipe 70 that is connected with the water level adjustment tank 40.

If the water supply to the water level adjustment tank 40 from the return tank 20 is stopped and the water level in the return tank 20 rises, the water is discharged through the overflow pipe 60 that is connected with the water storage tank 30.

Finally, if the water level in the water level adjustment tank 40 rises above the overflow pipe 60 that is connected with the return tank 20, the water flows into the overflow pipe 60 and is discharged to the return tank 20.

The water stored in the water storage tank 30 flows through the supply pipe 70 that is connected with the water level adjustment tank 40.

The supply pipe 70 is respectively connected with the water storage tank 30 and the return tank 20 so as to receive the water.

The water, which is respectively discharged from a plurality of water level adjustment tanks 40 through the overflow pipes 60 connected with the water level adjustment tanks 40, gathers in a single pipe, and is supplied to the return tank 20 through the pump 21.

The supply pipes 70, which are connected with the water storage tank 30 and the return tank 20, are provided with valves 71, which are configured to open or close the supply pipes 70.

The valves 71 function to control the water supply by independently opening or closing the supply pipe 70 for supplying the water from the water level adjustment tank 40 and the supply pipe 70 for supplying the water from the water storage tank 30.

Therefore, by manipulating the valves 71 provided in the supply pipes 70, the water supply can be controlled such that the water is separately or simultaneously supplied from the water storage tank 30 and the return tank 20.

Since the valves 71 can be mounted so as to facilitate the supply and discharge of water to and from the water level adjustment tank 40 and the cultivation unit 50, a plurality of water level adjustment tanks 40 and a plurality of cultivation units 50 may be installed according to the installation environment.

As shown in FIG. 3, a plug 90, which is connected with a buoyant float 91, is coupled to an end of the supply pipe 70 inside the water level adjustment tank 40 so as to control the amount of water that flows into the water level adjustment tank 40 through the supply pipe 70.

The plug 90, as shown in FIG. 3a, is coupled to the end of the supply pipe 70, which is inserted into the water level adjustment tank 40, and if the water level in the water level adjustment tank 40 drops, the plug 90 is opened, and accordingly the water is supplied to the water level adjustment tank 40 from the water storage tank 30 and the return tank 20.

However, as shown in FIG. 3b, if the water level in the water level adjustment tank 40 reaches a predetermined level, the plug 90 is closed by the buoyancy of the buoyant float 91, and consequently the water supply is stopped.

As a result, the water level in the water level adjustment tank 40 is constantly maintained at a predetermined level in such a manner that when the amount of water in the water level adjustment tank 40 is excessive, the water is discharged and stored in the return tank 20, and when the amount of water in the water level adjustment tank 40 is decreased, the water stored in the return tank 20 is supplied to the water level adjustment tank 40.

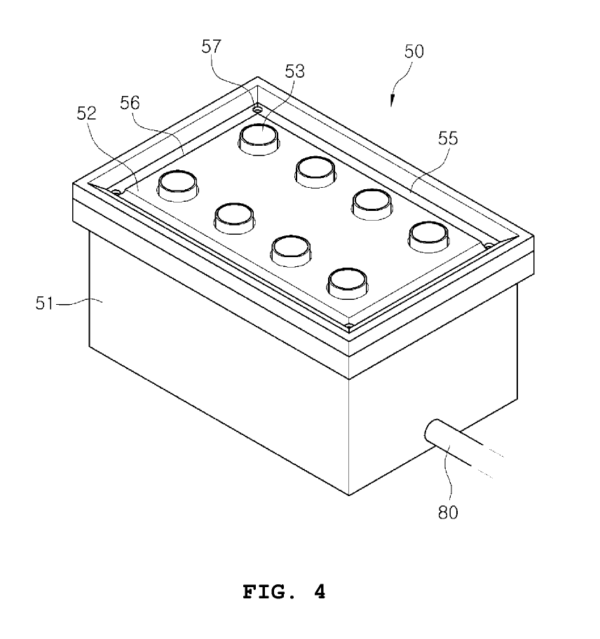

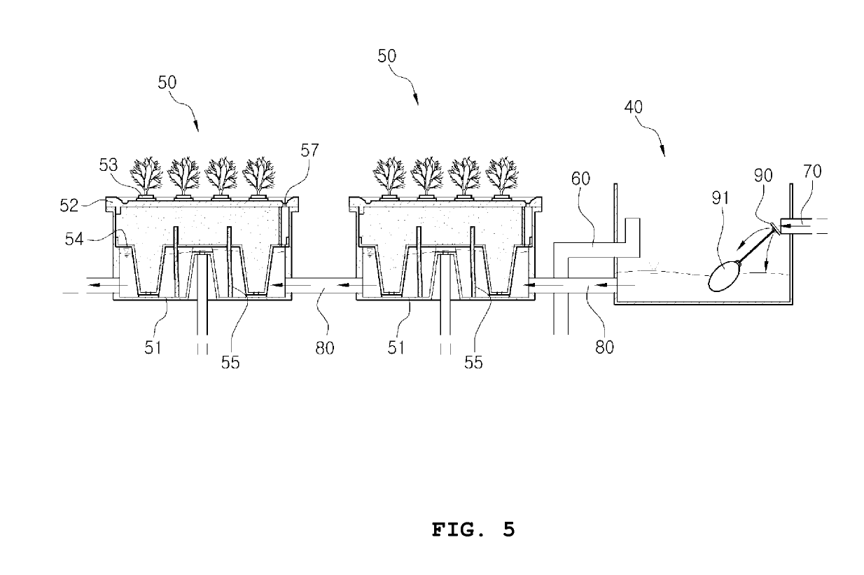

FIG. 4 is a perspective view illustrating the cultivation unit according to the present invention, and FIG. 5 is a sectional view illustrating the state in which water is supplied to the cultivation unit according to the present invention.

As shown in FIG. 4, the cultivation unit 50 includes a reservoir 51, which is connected with the water level adjustment tank 40 through a water transfer pipe 80 to receive and discharge the water so as to maintain the same water level as that in the water level adjustment tank 40, and a pot plate 52, to which a pot 53 for planting plants is mounted.

As shown in FIG. 5, the pot plate 52 of the cultivation unit 50 has a through-hole, in which the pot 53 is fitted, and the reservoir 51 is coupled to the bottom portion of the pot plate 52 to store the water and supply the water to the plants planted in the pot 53 through a wick 54.

The pot 53 coupled to the pot plate 52 protrudes upwards from the top surface of the pot plate 52, thereby preventing the rainwater gathering on the top surface of the pot plate 52 from flowing into the pot 53.

The pot plate 52 has a protrusion 56 formed at the bottom portion thereof, and the reservoir has a coupling recess 57 formed at the top portion thereof so as to correspond to the protrusion 56.

The engagement of the protrusion 56 and the coupling recess 57 prevents the pot plate 52 and the reservoir 51 from being undesirably separated from each other due to wind, external shocks, etc.

Further, since a plurality of cultivation units 50 can be arranged while being connected with the water level adjustment tank 40 through the water transfer pipe 80, the number of cultivation units to be installed can be decreased or increased suitably for the installation site and the kind of plant.

A guide groove 55, for guiding the rainwater, and a water inflow recess 55a, through which the rainwater guided by the guide groove 55 flows into the reservoir 51, are formed in the top surface of the pot plate 52.

The reservoir 51 can receive and store the rainwater supplied from the top surface of the pot plate 52, and if the water level in the reservoir 51 rises, the water is discharged to the water level adjustment tank 40 through the water transfer pipe 80.

As such, even if the water level in the reservoir 51 rises above a predetermined level, the water level in the reservoir 51 can be adjusted by discharging the water to the water level adjustment tank 40, and the water can be further discharged to the return tank 20 via the water level adjustment tank 40.

A moisture supply groove 58 is formed in the center portion of the top surface of the pot plate 52, and a plurality of supply recesses 58a, through which moisture and nutrient solution are supplied into the pot plate 52, are formed in the top surface of the pot plate 52.

Therefore, if the moisture and the nutrient solution are supplied to the moisture supply groove 58, they can be stored in the pot plate 52 through the supply recesses 58a, and can be prevented from flowing into the reservoir 51 through the guide groove 55 because the moisture supply groove 58 and the supply recesses 58a are provided at a position distant from the guide groove 55.

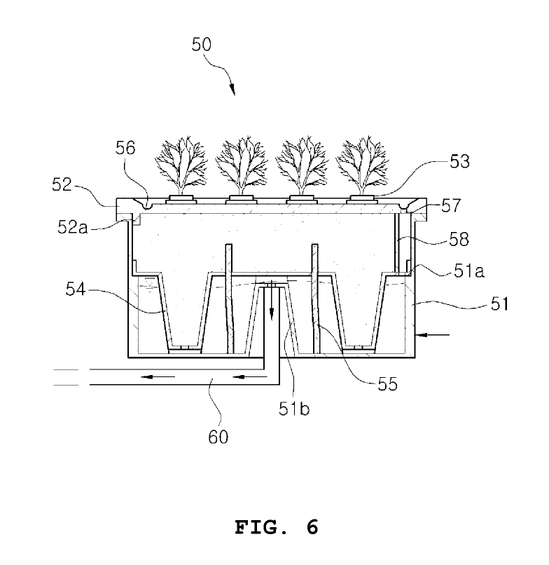

FIG. 6 is a sectional view illustrating the state in which the cultivation unit according to the present invention is separately installed, and as shown in FIG. 6, the cultivation unit 50 can be separately installed so as to be used indoors, such as in houses, verandas or the like.

Herein, the water transfer pipe 80 coupled to the reservoir 51 is replaced by the overflow pipe 60 so that if the water level in the reservoir 51 exceeds a predetermined level, the water is discharged outside.

That is, after the cultivation unit 50 is separately installed, the water can be supplied and stored in the reservoir 51 through the guide groove 55 and the water inflow recess 55a, and if the water level in the reservoir 51 exceeds a predetermined level, the water is discharged outside through the overflow pipe 60.

Moisture and nutrient solution are guided by the moisture supply groove 58, and are stored in the pot plate 52 through the supply recesses 58a, thereby supplying nutrients to plants.

The scope of the present invention should not be limited to the description of the embodiment, but defined by the accompanying claims and equivalents thereof, and it will be apparent to those skilled in the art that various modifications and variations can be made in the present invention without departing from the spirit or scope of the invention.

### [Explanation of Reference Numerals]

| | |
|---|---|
| 10: Rainwater Storage Tank | 20: Return Tank |
| 21: Pump | 30: Water Storage Tank |
| 40: Water Level Adjustment Tank | 50: Cultivation Unit |
| 51: Reservoir | 52: Pot Plate |
| 53: Pot | 54: Wick |
| 55: Guide Groove | 55a: Water Inflow Recess |
| 56: Protrusion | 57: Coupling Recess |
| 58: Moisture Supply Groove | 58a: Supply Recess |
| 60: Overflow Pipe | 70: Supply Pipe |
| 71: Valve | 80: Water Transfer Pipe |
| 90: Plug | 91: Buoyant Float |

What is claimed is:

1. A cultivation apparatus having an automatic rainwater supply function to cultivate plants using rainwater stored therein, the cultivation apparatus comprising:
a rainwater storage tank for receiving and storing rainwater;
a return tank for storing water flowing thereinto through a pump and discharging the water stored therein;
a water storage tank connected with the rainwater storage tank and the return tank through overflow pipes, the water storage tank receiving and storing water whose level is higher than the overflow pipes;
a water level adjustment tank for receiving water from the water storage tank and the return tank through supply pipes and discharging water through the overflow pipe, which is connected with the return tank, if a water level in the water level adjustment tank exceeds a predetermined level; and
a cultivation unit including a reservoir connected with the water level adjustment tank through a water transfer pipe to receive and discharge water so as to maintain the same water level as that in the water level adjustment tank, and a pot plate, to which a pot for planting plants is mounted.

2. The cultivation apparatus having an automatic rainwater supply function according to claim 1, wherein when the water level is higher than the overflow pipes, which are connected with the rainwater storage tank, the water storage tank, the return tank and the water level adjustment tank, the water flows into the overflow pipes and is discharged from the overflow pipes.

3. The cultivation apparatus having an automatic rainwater supply function according to claim 1, wherein the supply pipes are provided with plugs coupled to ends thereof inside the water level adjustment tank, each of the plugs being connected with a buoyant float so as to control the amount of water that flows into the water level adjustment tank.

4. The cultivation apparatus having an automatic rainwater supply function according to claim 1, wherein the cultivation unit includes a pot plate having a through-hole, in which the pot is fitted, and a reservoir coupled to a bottom portion of the pot plate to store water and supply the water to plants planted in the pot through a wick.

5. The cultivation apparatus having an automatic rainwater supply function according to claim 1, wherein the pot plate includes a guide groove for guiding rainwater and a water inflow recess for allowing the rainwater guided by the guide groove to flow into the reservoir, the guide groove and the water inflow recess being formed in a top surface of the pot plate.
